(19) United States
(12) Patent Application Publication
(10) Pub. No.: US 2024/0110082 A1
(43) Pub. Date: Apr. 4, 2024

(54) RELEASE LINER

(71) Applicant: tesa SE, Norderstedt (DE)

(72) Inventors: Florian Rettig, Hamburg (DE); Ingo Neubert, Norderstedt (DE)

(73) Assignee: tesa SE, Norderstedt (DE)

(21) Appl. No.: 18/477,928

(22) Filed: Sep. 29, 2023

(30) Foreign Application Priority Data
Sep. 30, 2022 (DE) 102022125435.6

(51) Int. Cl. C09J 7/40; B32B 7/06; B32B 27/08; B32B 27/28; B32B 27/32

(52) U.S. Cl. CPC C09J 7/403; B32B 7/06; B32B 27/08; B32B 27/285; B32B 27/32; C09J 7/405; B29C 48/08; C09J 2301/302; C09J 2301/414; C09J 2423/005; C09J 2423/045; C09J 2423/105; C09J 2483/005

(57) ABSTRACT

A release liner that can be produced in a few method steps (e.g., a coextrusion step), exhibits very good interlaminate adhesion, and has little tendency to deform and deviate from planarity. The release liner is for use on pressure-sensitive adhesives and comprises:
a layer system (POL) comprising one or more layers and comprising in each layer, based in each case on the total weight of the layer, a total of at least 80% by weight of one or more polyolefins, where each layer of the layer system (POL) comprises polypropylene;
at least one layer (PEL) comprising, based on the total weight of the layer (PEL), at least 80% by weight of polyethylene; and
an anchoring layer that connects each layer (PEL) to the layer system (POL).

### CROSS-REFERENCE TO RELATED APPLICATIONS

This application claims the benefit of priority under 35 U.S.C. § 119(b) of German Patent Application No. 102022125435.6, entitled RELEASE LINER, and filed Sep. 30, 2022, the contents of which is relied upon and incorporated herein by reference in its entirety.

### FIELD OF THE DISCLOSURE

The invention relates to the technical field of release liners of the type frequently used for the protection of pressure-sensitive adhesives. More specifically, the invention relates to a release liner which in its structure comprises at least two polyolefin-based layers connected to one another by an anchoring layer.

### BACKGROUND

Adhesive tapes coated on one or both sides with adhesives are mostly wound up at the end of the production process to give a roll in the form of an Archimedean spiral or to give a cross-wound spool. In the case of double-sided adhesive tapes, the adhesive is covered with a covering material (also termed release material) prior to winding of the adhesive tape, in order to prevent contact between the pressure-sensitive adhesives, or in the case of single-sided adhesive tapes to ensure easier unrolling. The term used by the skilled person for such covering materials is release liners or just liners. Liners are used not only for the covering of single- or double-sided adhesive tapes but also for the enveloping of labels.

The release liners further ensure that the adhesive is not soiled before use. It is also possible, by way of the nature and composition of the release materials, to adjust release liners in a manner that permits use of the desired force (small or large) to unroll the adhesive tape. Another function of the release liners in the case of adhesive tapes coated on both sides with adhesive is to ensure that the correct side of the adhesive is uncovered first during unrolling.

A liner or release liner is not a constituent of an adhesive tape or label, but instead is merely an aid to production and storage thereof, or for further processing. A liner accordingly is unlike, say, an adhesive tape carrier in that it has no permanent connection to a layer of adhesive.

Release liners used in industry comprise carriers made of paper or of film which are equipped with an abhesive coating composition (also termed dehesive or anti-adhesive composition) in order to reduce the tendency of adherent products to adhere to these surfaces (release function). Abhesive coating compositions used, also called release coatings, can comprise a wide variety of different materials: waxes, fluorinated or partially fluorinated compounds and in particular silicones and various copolymers with silicone content. Silicones have become widely established as release materials in the field of adhesive tape applications in recent years, because of their good processability, low cost and wide range of properties.

There is now also interest in liners with polyolefin release layers, as well.

WO 2020/042139 A1 describes a laminate which comprises
a fiber layer of propylene-based polymer fibers,
a covering of one or more ethylene-based polymers, and
an anchoring layer arranged between the fiber layer and the covering,
   where the anchoring layer is composed of at least 50% by weight of a crystalline block composite (CBC) and of an optional mixing component and the CBC comprises
(i) an isotactic crystalline propylene homopolymer (iPP);
(ii) an ethylene/propylene copolymer; and
(iii) a diblock of the formula (EP)-(iPP);
   where the CBC has a block composite index (CBCI) of 0.1 to 1.0 and the laminate has a peel force of 20 N/15 mm to 40 N/15 mm.

EP 2 354 203 A1 relates to a pressure-sensitive adhesive tape which can be utilized at temperatures of at least 90° C. or more and comprises
a pressure-sensitive adhesive layer; and
a release liner which is arranged on the surface of at least one side of the pressure-sensitive adhesive layer,
where the release liner comprises a base layer comprising a polyolefin resin; and
a release layer which comprises low-density polyethylene and is arranged on at least one side of the base layer such that it is in contact with the pressure-sensitive adhesive layer.

EP 2 298 844 A1 discloses a pressure-sensitive acrylate adhesive tape which has a pressure-sensitive adhesive layer and a release liner and is characterized in that:
the pressure-sensitive adhesive layer is an acrylate pressure-sensitive adhesive layer which comprises inorganic filler, is interspersed with cavities and comprises an acrylate polymer formed from an acrylate monomer mixture containing
an alkyl (meth)acrylate ester (a) having a C₁-C₁₄ alkyl group and a vinyl monomer (b) containing a polar group, in a weight fraction [(a)/(b)] of 95/5 to 91/9;
an inorganic filler in a fraction of 0.1 part by weight or more and less than 2 parts by weight, based on 100 parts by weight of all the monomers forming the acrylate polymer;
and cavities;
   and in that the release liner has an at least three-layer structure comprising a low-density polyethylene layer as a surface layer, a mixed resin layer containing a low-density polyethylene and a high-density polyethylene as resin components, as the other surface layer, and additionally a high-density polyethylene layer as intermediate layer.

EP 2 426 185 A1 describes an article construction comprising:
a plastic or elastomeric article;
a double-sided adhesive tape comprising adhesive front and back sides, each of which comprises a pressure-sensitive adhesive;
a release liner which has a release side comprising a release material in contact with, connected to and easily removable from one of the aforesaid adhesive sides, and a liner reverse side; and
a grip tab which is connected to the aforesaid first liner reverse side, the aforesaid grip tab being operatively adapted to enable the removal of the release liner from the adhesive tape.

A subject of WO 2017/039953 A1 is a resin which can be utilized as an anchoring layer in a multi-ply construction, where the resin comprises
a high-density polyethylene having a density of more than 0.960 g/cm³, where the high-density polyethylene makes up 1% to 99% by weight of the resin; and
a high-density polyethylene grafted with maleic anhydride, where the maleic anhydride-grafted high-density polyethylene makes up 1% to 99% by weight of the resin; and
   a catalyst comprising at least one Lewis acid.

Lastly, EP 3 278 984 A1 describes a release liner for use on pressure-sensitive adhesives, comprising
an outer silicone release layer (SR);
a layer system (POL), comprising in each of its layers, at a total of at least 50% by weight, based in each case on the total weight of the layer, one or more polyolefins, where the layer system (POL) comprises at least 60% by weight of polypropylene, based on the total weight of the layer system (POL); and
an outer layer (PER), comprising at least 80% by weight of polyethylene, based on the total weight of the layer (PER), where the layer (PER) is connected by an adhesive to the next layer in the structure of the release liner. The adhesive for connecting the layer systems within the release liner is preferably polyurethane-based.

Release liners like those described in EP 3 278 984 A1 specifically have a high performance capacity fundamentally; the laminating adhesives used are in general a match for the exacting requirements imposed on the durability of the film layers to be anchored to one another, in the z-direction—for example, when the adhesive tape is being wound up to form the roll or spool. However, they are decidedly expensive and technically complicated to produce, requiring the extrusion of at least two films and their subsequent lamination to one another in an additional step. Furthermore, in the case of constructions made up of polyolefin films which are produced using polyurethane-based adhesives, the issue of recyclability arises as well. Moreover, disadvantages due to “curling” are observed—if a laminating adhesive is used on only one side of a liner, the liner frequently displays a tendency to deform and does not retain the desired planarity.

### SUMMARY OF THE DISCLOSURE

A fundamental object of the present invention was to remove the disadvantages known from the prior art, or at least to minimize them. More specifically, an object of the invention was to provide a release liner which can be produced in a few method steps and hence very rationally. A further object of the invention was to provide a multi-ply release liner which exhibits very good interlaminate adhesion of the plies. A supplementary object of the invention was to provide a release liner featuring pronounced planarity and little tendency to deform and deviate from planarity.

A first and general subject of the invention, which achieves these objects, is a release liner for use on pressure-sensitive adhesives, comprising
a layer system (POL) comprising one or more layers and comprising in each layer, based in each case on the total weight of the layer, a total of at least 80% by weight of one or more polyolefins, where each layer of the layer system (POL) comprises polypropylene; and
at least one layer (PEL) comprising, based on the total weight of the layer (PEL), at least 80% by weight of polyethylene,
where an anchoring layer connects each layer (PEL) to the layer system (POL).

It has emerged that a release liner of this kind can be produced by a co-extrusion and hence in just a single working step. Excellent internal adhesion of the layer systems has been observed. Moreover, it has been possible to produce the liner both in a symmetrical construction and in an asymmetrical construction. As well as the fact that this opens up a great diversity of design options, the symmetrical construction in particular has proved to be very advantageous in relation to the constant planarity of the release liner.

According to an aspect of the disclosure, a release liner is provided that includes: a POL layer system comprising one or more layers; at least one PEL layer; and an anchoring layer, the anchoring layer connects each PEL layer to the POL layer system. Further, each layer of the POL system has at least 80% by weight of one or more polyolefins, based on a total weight of the layer of the POL layer system. Each layer of the POL layer system comprises polypropylene. Each PEL layer comprises at least 80% by weight of polyethylene, based on a total weight of the PEL layer. In addition, the anchoring layer comprises at least one polyolefin copolymer.

According to an aspect of the disclosure, a method for producing a release liner is provided that includes: a step of coextruding a release liner. The release liner includes: a POL layer system comprising one or more layers; at least one PEL layer; and an anchoring layer, the anchoring layer connects each PEL layer to the POL layer system. Further, each layer of the POL system has at least 80% by weight of one or more polyolefins, based on a total weight of the layer of the POL layer system. Each layer of the POL layer system comprises polypropylene. Each PEL layer comprises at least 80% by weight of polyethylene, based on a total weight of the PEL layer. In addition, the anchoring layer comprises at least one polyolefin copolymer.

According to a further aspect of the disclosure, a release liner is provided that includes: a POL layer system comprising one or more layers; at least one PEL layer; and at least one anchoring layer, each anchoring layer connects each PEL layer to the POL layer system. Further, each layer of the POL system has at least 80% by weight of one or more polyolefins, based on a total weight of the layer of the POL layer system. Each layer of the POL layer system comprises polypropylene. Each PEL layer comprises at least 80% by weight of polyethylene, based on a total weight of the PEL layer. In addition, the at least one anchoring layer comprises at least one ethylene-propylene copolymer and a thickness of not more than 20 μm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding, and are incorporated in and constitute a part of this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

Further details and features of the present invention are apparent from the description of figures and working examples. Here, the respective features may be realized on their own or as two or more in combination with one another. The invention is not confined to the working examples, The working examples are represented schematically in the figures. Identical reference numerals in the individual figures here denote identical or functionally identical elements or elements which correspond to one another in terms of their functions.

FIG. 1 is a cross-sectional view of a release liner, according to one or more embodiments of the disclosure;

FIG. 1A is a cross-sectional view of a release liner, according to one or more embodiments of the disclosure; and

FIG. 1B is a cross-sectional view of a release liner, according to one or more embodiments of the disclosure.

### DETAILED DESCRIPTION

In the following detailed description, for purposes of explanation and not limitation, example embodiments disclosing specific details are set forth to provide a thorough understanding of various principles of the release liner of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an,” and “the” include plural referents unless the context clearly dictates otherwise. Thus, for example, reference to a “component” includes aspects having two or more such components, unless the context clearly indicates otherwise.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

The meaning of the expression “pressure-sensitive adhesive” in the invention is the generally accepted meaning: a substance which—in particular at room temperature—is durably tacky and adhesive. A pressure-sensitive adhesive has the characteristic feature that it can be applied by pressure to a substrate and continues to adhere thereon; neither the pressure that has to be exerted nor the duration of exposure to the said pressure is defined in general in any more detail. In some cases, depending on the precise type of pressure-sensitive adhesive, the temperature and the humidity, and also the substrate, a short period of exposure to a minimal pressure not exceeding gentle contact for a brief moment is sufficient to achieve the adhesion effect; in other cases there can also be a need for more prolonged exposure to a high pressure.

Pressure-sensitive adhesives have particular, characteristic viscoelastic properties which provide the durable tack and adhesion. They are characterized in that mechanical deformation results not only in viscous flow processes but also in build-up of elastic recovery forces. There is a particular relationship between the respective components provided by the two processes, this being dependent not only on the precise composition, on the structure and on the degree of crosslinking of the pressure-sensitive adhesive but also on the deformation rate and deformation time, and on the temperature.

The viscous flow component is necessary in order to achieve adhesion. The viscous components deriving from macromolecules with relatively high freedom of motion are solely responsible for good wetting and good flow onto the substrate requiring adhesive bonding. A large viscous flow component leads to high tack (also known as surface tack) and with this often also high peel adhesion. Highly crosslinked systems, and crystalline or glassy polymers, exhibit no tack or at least only little tack because they have insufficient flowable components.

The components providing elastic recovery forces are necessary to achieve cohesion. They can derive by way of example from macromolecules that have very long chains and are highly intertwined, and/or from macromolecules that have been physically or chemically crosslinked, and they permit transmission of the forces acting on an adhesive bond. They allow an adhesive bond to withstand, to a sufficient extent for a prolonged period, a long-term load to which it is exposed, for example taking the form of a long-term shear load.

The magnitude of elastic and viscous components and the ratio of the components to one another can be described and quantified more precisely by using the variables storage modulus (G′) and loss modulus (G″), which can be determined by means of dynamic mechanical analysis (DMA). G′ is a measure of the elastic component, and G″ is a measure of the viscous component of a substance. Both variables depend on deformation frequency and temperature.

The variables can be determined with the aid of a rheometer. The material requiring investigation here is by way of example exposed in a plate-on-plate arrangement to a sinusoidally oscillating shear stress. In the case of shear-stress-controlled equipment, deformation is measured as a function of time, and the time-based offset of this deformation is measured relative to the introduction of the shear stress. This time-based offset is termed phase angle δ.

Storage modulus G′ is defined as follows: G′=(τ/γ)·cos (δ) (τ=shear stress, γ=deformation, δ=phase angle=phase shift between shear stress vector and deformation vector). Loss modulus G″ is defined as follows: G″=(τ/γ)·sin (δ) (τ=shear stress, γ=deformation, δ=phase angle=phase shift between shear stress vector and deformation vector).

A substance is generally regarded as exhibiting tack if at room temperature, defined here as 23° C., in the deformation frequency range from 100 to 101 rad/sec, G′ is at least to some extent in the range from 103 to 107 Pa and G″ is likewise at least to some extent in the said range. “To some extent” means that at least a section of the G′ curve is within the window defined by the deformation frequency range from, and including, 100 to, and including, 101 rad/sec (abscissa) and by the range of the G′ values from, and including, 103 to, and including, 107 Pa (ordinate). For G″ this applies correspondingly.

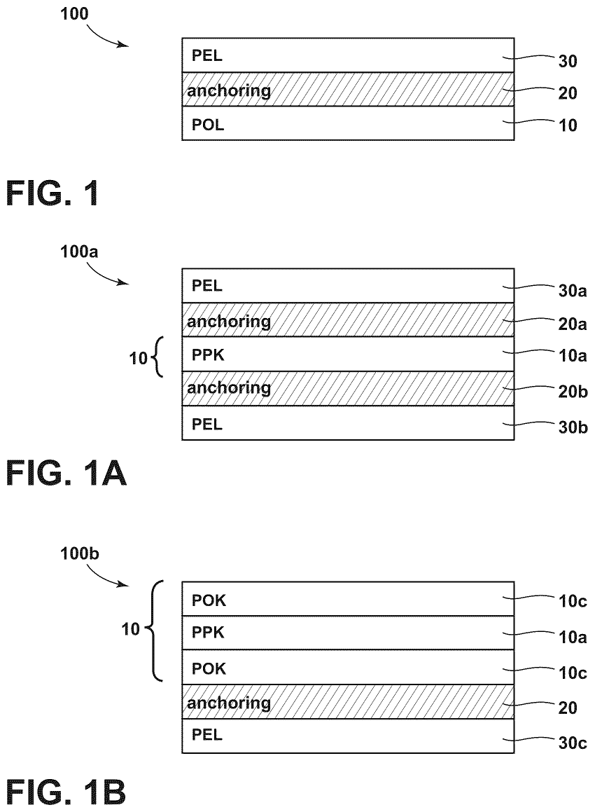

Referring to FIG. 1, a release liner 100 is provided that includes: a POL layer system 10 comprising one or more layers; at least one PEL layer 30; and an anchoring layer 20, the anchoring layer 20 connects each PEL layer 30 to the POL layer system 10. Further, each layer of the POL layer system 10 has at least 80% by weight of one or more polyolefins, based on a total weight of the layer of the POL layer system 10. Each layer of the POL layer system 10 comprises polypropylene. Each PEL layer 30 comprises at least 80% by weight of polyethylene, based on a total weight of the PEL layer. In addition, the anchoring layer 20 comprises at least one polyolefin copolymer.

The release liner of the invention (e.g., release liner 100 depicted in FIG. 1) comprises a layer system (POL) which comprises one or more layers and in each layer comprises a total of at least 80% by weight, based in each case on the total weight of the layer, of one or more polyolefins, with each layer of the layer system (POL) comprising polypropylene. A “layer system” refers to a delimitable part of the layer construction of the release liner of the invention, and, in the case of a multilayer system, the layers in this system follow one another directly. The expression “. . . comprises in each layer”, in accordance with the above, also encompasses a single-layer system and in that case is to be understood as “. . . comprises in this layer”.

The layer system (POL) (e.g., POL layer system 10 depicted in FIG. 1) preferably comprises a layer (PPK) which comprises at least 60% by weight, more preferably at least 70% by weight, more particularly at least 80% by weight, for example at least 90% by weight of polypropylene, based in each case on the total weight of the layer. It has emerged that polypropylene levels of this kind are advantageous for the thermal stability of the layer (PPK), of the overall layer system (POL) and of the release liner of the invention. With particular preference, the layer (PPK) consists of polypropylene blended to an extent of not more than 15% by weight, more preferably not more than 10% by weight, with colorants. The layer (PPK) is preferably colored using pigments or organic dye which have been added in the form of a color masterbatch.

The layer (PPK) consists in particular of a heterophasic polypropylene copolymer having a colorant fraction of not more than 15% by weight, more preferably having a colorant fraction of not more than 10% by weight.

With particular preference, the material of the layer (PPK) has a melting temperature of at least 160° C. The polypropylene of the layer (PPK) is preferably what is called a heterophasic PP copolymer (HECO PP, impact PP). A copolymer of this kind has, in particular, a high temperature stability. The temperature stability, which is a result of the melting temperature, is comparable with that of pure homo-PP. A heterophasic PP copolymer, however, features better flexibility and also lower strength and lower brittleness. This is achieved by copolymerizing propylene with a certain, smaller fraction of EP rubber.

In one embodiment of the release liner of the invention, the layer system (POL) consists of a layer (PPK).

In a further embodiment of the release liner of the invention, the layer system (POL) comprises a layer (PPK) and a polyolefin layer (POK) which directly follows the layer (PPK) and comprises at least 25% by weight, more preferably at least 30% by weight, more particularly at least 35% by weight of polyethylene and also at least 20% by weight, more preferably at least 30% by weight, more particularly at least 50% by weight of polypropylene, based in each case on the total weight of the polyolefin layer (POK). With very particular preference, the polyolefin layer (POK) comprises at least 70% by weight, more preferably at least 80% by weight, or particularly at least 90% by weight, based in each case on the total weight of the polyolefin layer (POK), of a mixture of polyethylene and polypropylene in a PP/PE weight ratio of 40/60 to 80/20, particularly of 50/50 to 70/30, for example of 55/45 to 65/35. More preferably, the polyolefin layer (POK) consists of such a mixture of polypropylene and polyethylene.

With particular preference, the polypropylene of the polyolefin layer (POK) is a heterophasic PP copolymer, e.g. an impact polypropylene. The polyethylene of the polyolefin layer (POK) is preferably produced using metallocene catalysis (mPE); in particular, it is a so-called linear low-density polyethylene (LLDPE). By way of the PP/PE blend ratio it is possible advantageously to fine-tune the mechanical properties of an assembly made up in each case of one or more layers (PPK) and (POK), especially its strength. The mechanical properties of this assembly have particular consequences when the assembly is coated with a silicone release composition. This is manifested in a particularly positive way when the release liner of the invention is applied, especially when it is processed by machine, and when it is used, when an adhesive tape lined with it is bonded around curves. With particular advantage, the release liner or at least the assembly described has a good stretch resistance and in this way counteracts any stretching or over-extension of the adhesive tape when it is being applied and processed. It is notable that, accordingly, an assembly made up of the layers (PPK) and (POK) achieves a particularly good balance between the two opposing properties of stretchability and stretch resistance.

The raw materials for producing the layers (PPK) and (POK) and hence in particular the layer (PPK), or the layers (PPK) and (POK), preferably have, on a weight basis, less than 1000 ppm of catalyst poisons in terms of the hydrosilylation catalyst of a silicone-based release layer which is indeed preferred in the context of the invention but fundamentally is optional. Otherwise, disruptions to the silicone crosslinking may occur, possibly interfering with the release properties of the release layer. Relevant catalyst poisons include, in particular, compounds containing phosphorus and compounds containing nitrogen, examples being phosphite stabilizers such as Irgafos 168 or Irgafos TNPP, lubricants or antistats having amide or amine functionalities, e.g. erucamide. With particular preference, the raw materials for the production of the layer (PPK) or of the layers (PPK) and (POK), and hence in particular the layer (PPK) or the layers (PPK) and (POK), are free from catalyst poisons in terms of the hydrosilylation catalyst of a silicone-based release layer.

In a further embodiment, the layer system (POL) comprises a layer (PPK) and, on each of its top and bottom sides, a polyolefin layer (POK) directly following the layer (PPK), as described above. In this embodiment, the two layers (POK) may in principle have identical or different layer thicknesses; preferably, they have different layer thicknesses.

The liner of the invention further comprises at least one layer (PEL) (e.g., PEL layer 30 as depicted in FIG. 1) which comprises at least 80% by weight of polyethylene. The layer (PEL) preferably comprises at least 90% by weight, more preferably at least 95% by weight, more particularly at least 98% by weight, for example at least 99% by weight of polyethylene, based in each case on the total weight of the layer (PEL). With very particular preference, the layer (PEL) consists of polyethylene; in this case it may also consist of a blend or a mixture of different ethylene polymers.

The polyethylene of the layer (PEL) is preferably a low-density PE (LDPE); with particular preference, the layer (PEL) consists of LDPE.

The layer (PEL) preferably has a layer thickness of 10 to 45 μm, more preferably of 12 to 40 μm, more particularly of 15 to 33 μm.

The LDPE of the layer (PEL) preferably has a density of less than 0.925 g/cm³, particularly of less than 0.92 g/cm³. A layer (PEL) equipped in this way has particularly low release forces or unwind forces for pressure-sensitive adhesives; therefore, there is no need for an additional silicone release coating. The layer (PEL) therefore also has a particularly high heat resistance. This in turn opens up the possibility of applying a grip aid to the layer (PEL) by means of a heat-sealing process. Preferably, therefore, the layer (PEL) is an outer layer of the release liner of the invention, and a grip aid is applied to a portion of the layer (PEL).

In accordance with the invention, each layer (PEL) of the release liner is connected to the layer system (POL) by an anchoring layer. In this way, it has become possible to produce the layer structure of the release liner of the invention by a coextrusion and hence at significantly greater efficiency than in the conventional method of extruding different films and laminating them to form the release liner structure. It has emerged that a release liner of the invention is better able to meet the demanding stresses in use than conventional liners produced, in particular, using laminating adhesives.

The anchoring layer preferably comprises at least one polyolefin, more preferably at least one polyolefin copolymer. In particular, the anchoring layer comprises at least one ethylene-propylene block copolymer, and very preferably comprises an ethylene-propylene block copolymer to an extent of at least 80% by weight, more particularly at least 90% by weight, for example at least 95% by weight. The anchoring layer consists very preferably of one or more ethylene-propylene block copolymers.

The anchoring layer or anchoring layers (e.g., anchoring layer 20 depicted in FIG. 1) of the release liner preferably have a layer thickness of not more than 20 μm, more preferably of not more than 15 μm, particularly of not more than 10 μm, with particular preference of not more than 8 μm.

According to how many layers (PEL) it comprises, the release liner of the invention may comprise one or two anchoring layers. Where there are two anchoring layers, the statements marked above as in any way preferred are valid in principle for both anchoring layers.

In one embodiment, the release liner 100a (as depicted in FIG. 1A) of the invention comprises
a layer system (POL) 10 consisting of a layer (PPK) 10a and
on the top and bottom sides of the layer (PPK) 10a, a respective layer (PEL) 30a, 30b, where each layer (PEL) 30a, 30b is connected to the layer (PPK) 10a by an anchoring layer 20a, 20b. In this embodiment, therefore, the release liner comprises the following layer sequence: (PEL) layer 30a/anchoring layer 20a/(PPK) layer 10a/anchoring layer 20b/(PEL) layer 30b.

Preferably, both the two layers (PEL) 30a, 30b and the two anchoring layers 20a, 20b of the release liner 100a have substantially identical layer thicknesses, and so in this embodiment the structure of the release liner is preferably symmetrical.

In a further embodiment, the release liner 100b (as depicted in FIG. 1B) of the invention comprises
a layer system (POL) 10 consisting of a layer sequence (POK) layer 10c/(PPK) layer 10a/(POK) layer 10c and
on one side of the layer system (POL) 10, a layer (PEL) 30c, where the layer (PEL) 30c is connected by an anchoring layer 20 to the layer system (POL) 10, more specifically to one of the layers (POK) 10c. In this embodiment, then, the overall layer sequence of the release liner 100b is as follows:
   (POK) layer 10c/(PPK) layer 10a/(POK) layer 10c/anchoring layer 20/(PEL) layer 30c.

The release liner 100b of this embodiment thus has an asymmetrical construction. Furthermore, the two layers (POK) 10c, 10c preferably have different layer thicknesses; in particular, the layer thickness of the layer (POK) 10c connected to the anchoring layer 20 is less than the layer thickness of the layer (POK) 10c not connected to the anchoring layer 20.

Independently of its layer structure, the release liner of the invention, in addition to the layers described so far, preferably comprises at least one silicone release layer. The silicone release layer is of course an outer layer of the release liner, thus forming one of the two layers which outwardly delimit the layer structure of the liner, and thus having a free side.

The silicone release layer can preferably be derived from a crosslinkable silicone system. Among these crosslinkable silicone systems are mixtures of crosslinking catalysts and what are known as heat-curable condensation- or addition-crosslinking polysiloxanes. The silicone release layer can be derived from solvent-containing or solvent-free systems; it can preferably be derived from a solvent-containing system. The silicone release layer can preferably be derived from a radiation- (UV- or electron-beam-), condensation- or addition-crosslinking system, particularly preferably from an addition-crosslinking system.

Silicone-based release agents based on addition crosslinking can generally be cured by hydrosilylation. The formulations for the production of these release agents usually comprise the following constituents:

a linear or branched polydiorganosiloxane comprising alkenyl groups,
a polyorganohydrosiloxane crosslinking agent and
a hydrosilylation catalyst.

Platinum and platinum compounds have in particular proved successful as catalysts for addition-crosslinking silicone systems (hydrosilylation catalysts), an example being the Karstedt catalyst (a Pt(0) complex compound).

More specifically, these addition-crosslinking release coatings can comprise the following components:
a linear or branched polydimethylsiloxane which consists of about 80 to 200 dimethylsiloxane units and has terminal vinyldimethylsiloxy units at the chain ends. Typical examples are solvent-free, addition-crosslinking silicone oils having terminal vinyl groups, e.g. Dehesive® 921 or 610, both obtainable commercially from Wacker-Chemie GmbH;
a linear or branched crosslinking agent which either has only methylsiloxy units in the chain (homopolymer crosslinking agent) or is composed of methylsiloxy units and dimethylsiloxy units (copolymer crosslinking agent) and thus has Si—H groups, where the chain ends are saturated either by trimethylsiloxy groups or by dimethylsiloxy groups. Typical examples of this product class are polysiloxanes with high content of reactive Si—H, such as the crosslinking agents V24, V90 and V06, which are obtainable commercially from Wacker-Chemie GmbH;
an MQ silicone resin which also has, as M unit alongside the trimethylsiloxy units usually used, vinyldimethylsiloxy units. Typical examples of this group are the release-force regulators CRA® 17 and CRA® 42, obtainable commercially from Wacker-Chemie GmbH;
a silicone-soluble platinum catalyst, for example a platinum-divinyltetramethyldisiloxane complex which is usually termed Karstedt complex and which is obtainable commercially by way of example as catalyst OL from Wacker-Chemie GmbH.

The silicone release system is usually applied in the uncrosslinked condition and crosslinked subsequently.

Among the silicones mentioned, the addition-crosslinking silicones have the greatest commercial importance. However, an undesired property of these systems is their sensitivity to catalyst poisons, for example heavy metal compounds, sulfur compounds and nitrogen compounds (cf. in this connection “Chemische Technik, Prozesse and Produkte” [Chemical technology, processes and products] by R. Dittmeyer et al., Volume 5, 5th Edn., Wiley-VCH, Weinheim, Germany, 2005, Chapter 6-5.3.2, page 1142). A general rule is that electron donors can be regarded as platinum poisons (A. Colas, Silicone Chemistry Overview, Technical Paper, Dow Corning). Accordingly, phosphorus compounds such as phosphines and phosphites must also be regarded as platinum poisons. The effect of the presence of catalyst poisons is that the crosslinking reaction between the various constituents of a silicone release agent ceases or proceeds only to a small extent. The presence of catalyst poisons, in particular of platinum poisons, is therefore generally strictly avoided during the production of antiadhesive silicone coatings.

Particular embodiments of the silicone systems are polysiloxane block copolymers, for example those having a urea block and marketed by Wacker with the trade name “Geniomer”, or release systems made of fluorosilicones, which are in particular used for adhesive tapes with silicone adhesives.

It is, moreover, also possible to use photoactive catalysts, known as photoinitiators, in combination with UV-curable cationically crosslinking siloxanes based on epoxy and/or on vinyl ether, or with UV-curable siloxanes amenable to radical crosslinking, examples being acrylate-modified siloxanes. Electron-beam-curable silicone acrylates can likewise be used.

Photopolymerizable organopolysiloxane compositions can also be used. Mention may be made by way of example of compositions which are crosslinked by the reaction, in the presence of a photosensitizer, between organopolysiloxanes which have hydrocarbon moieties which have substitution by (meth)acrylate groups and which have direct bonding to silicon atoms (see, for example, EP 0 168 713 B1 or DE 38 20 294 C1). It is likewise possible to use compositions where the crosslinking reaction takes place in the presence of a photosensitizer between organopolysiloxanes having hydrocarbon moieties which have substitution by mercapto groups and which have direct bonding to silicon atoms and organopolysiloxanes having vinyl groups directly bonded to silicon atoms. These compositions are described by way of example in U.S. Pat. No. 4,725,630.

When organopolysiloxane compositions described by way of example in DE 33 16 166 C1 are used, these having hydrocarbon moieties which have substitution by epoxy groups and which have direct bonding to silicon atoms, the crosslinking reaction is induced via liberation of a catalytic quantity of acid obtained by photodecomposition of added onium salt catalysts. Other organopolysiloxane compositions curable by a cationic mechanism are materials which by way of example have terminal propenyloxysiloxane groups.

The silicone systems can also comprise further additions appropriate to an intended use, for example stabilizers or flow control agents.

In a particular embodiment of the invention, the silicone release layer is a pressure-sensitive adhesive Hkm comprising
at least one pressure-sensitive silicone adhesive Si-Hkm obtainable from a composition comprising
   at least one polysiloxane having a plurality of Si-alkenyl groups
   at least one substance having a plurality of Si—H groups
   at least one hydrosilylation catalyst, and
at least one silicone resin;
   where the peel adhesion of the pressure-sensitive adhesive Hkm increases with increasing weight per unit area. It is particularly preferable that the silicone release layer is a pressure-sensitive adhesive Hkm comprising
at least one pressure-sensitive silicone adhesive Si-Hkm obtainable from a composition comprising
   at least one polysiloxane having a plurality of Si-alkenyl groups
   at least one substance having a plurality of Si—H groups
   at least one hydrosilylation catalyst, and
   at least one silicone resin;
      where the peel adhesion of the pressure-sensitive adhesive Hkm increases with increasing weight per unit area, and the release force of the release liner in relation to any desired pressure-sensitive adhesive in contact with the silicone release layer (SR) is 2 to 100 cN/cm. In particular here, the release force of the release liner in relation to an adhesive tape which comprises a foamed polyacrylate-based layer, for example in relation to the adhesive tape tesa® ACX^{plus} 7812, is 2 to 100 cN/cm. It has been found overall that when the silicone release layer is a pressure-sensitive adhesive Hkm, very good release forces, in particular release forces that are not too low, are achieved in relation to high-viscosity polyacrylate-based pressure-sensitive adhesives.

The polysiloxane which is part of the pressure-sensitive silicone adhesive Si-Hkm and which has a plurality of Si-alkenyl groups is preferably a polydiorganosiloxane comprising a plurality of Si-vinyl groups, in particular a polydimethylsiloxane comprising a plurality of Si-vinyl groups.

The substance which is part of the pressure-sensitive silicone adhesive Si-Hkm and which has Si—H groups is preferably a linear or branched crosslinking agent composed of methylhydrosiloxy units and of dimethylsiloxy units, where the chain ends are saturated either by trimethylsiloxy groups or by dimethylhydrosiloxy groups.

The hydrosilylation catalyst is preferably a conventional, Pt-based catalyst for the addition reaction of the Si—H groups onto the alkenyl groups. The quantity of the said catalyst preferably present in the pressure-sensitive adhesive Hkm is from 50 ppm to 1000 ppm.

The silicone resin of the pressure-sensitive adhesive Hkm is preferably an MQ silicone resin. The silicone resin preferably comprises Si-bonded alkyl and/or alkenyl moieties, in particular methyl and/or vinyl moieties, particularly preferably methyl moieties on those valencies of the silicon atoms that are not allotted to Si—O—Si bridges.

The molar ratio of Si—H groups to the Si-alkenyl groups of the polysiloxane of the pressure-sensitive silicone adhesive Si-Hkm is preferably 1.3:1 to 7:1.

When the pressure-sensitive adhesive Hkm described is used as a silicone release layer of the liner according to the invention, the peel adhesion and, in association therewith, the release behavior of the release layer can be controlled advantageously by way of the layer thickness of the pressure-sensitive adhesive Hkm applied, and also by way of the content of the silicone resin. Increasing application weight of the pressure-sensitive adhesive Hkm results in an increase in the peel adhesion and therefore an increase in the separation forces required to remove the release liner from the adhesive covered therewith.

The release liner of the invention preferably has a silicone release layer as described above on just one of its two main sides. In the case of the asymmetrical structure of the release liner as described above, the release liner preferably has the following layer structure, and more preferably consists of the following layer structure:

silicone release layer-(POK)-(PPK)-(POK)-anchoring layer-(PEL).

A further subject of the invention is a method for producing a release liner of the invention, wherein the layer structure of the release liner is generated via coextrusion. Relative to a conventional method, in which the individual layers, as films, for example, are generated separately and then laminated to one another, the method of the invention is much more efficient and leads at least to comparable interlaminate adhesion of the release liner.

### EXAMPLES

The following example represents non-limiting examples of the release liners of the disclosure, including the methods of making them.

### Example 1

Liner 1 was prepared by coextrusion, as having the following layer structure:
30 μm low density polyethyline (LDPE) layer (0.919 g/cm³) [PEL layer];
20 μm layer of Infuse® 9010 olefin block copolymer from Dow [anchoring layer]; and
80 μm heterophasic impact polypropylene (PP) copolymer layer with 8% by weight color batch [POL layer system]. Further, the tab for the tests (as described below) was attached on the LDPE layer side of the release liner.

Liner 2 (comparative example) was prepared by lamination (halftone rolls), as having the following layer structure:
30 μm LDPE (0.919 g/cm³);
2 μm two-component polyurethane laminating adhesive system (Liofol® UR 7780/UR6080, Henkel); and
80 μm heterophasic impact polypropylene copolymer layer with 8% by weight color batch. Further, the tab for the tests (as described below) was attached on the LDPE layer side of the release liner.

### Delamination Test used in Example 1

The liner under test is trimmed to a width of 15 mm. A tab likewise 15 mm wide and made of polyethylene terephthalate (PET)/polyethylene (PE) laminate is welded to the material under test at 190° C. for 3 seconds at a pressure of 3 bar by means of a metal stamp having an area of 15×15 mm. After the assembly thus produced has been cooled, it is pulled apart in freely hanging form (T-peel) at a rate of 300 mm/min. During this procedure, the force required to generate adhesive fracture at the layer interface (POL)-(PEL) or LDPE-PP interface is recorded. This measurement produces two measured values:
a relatively high initial peak, which corresponds to the initial delamination, and
a constant measured value, which corresponds to the actual delamination force (N/cm) of the two materials. Here, the second, constant measured value is the value reported.

### Tabbing Test used in Example 1

Two strips of the test tape furnished with the liner (tesa® ACX^{plus} 7812) are applied at a distance of about 1 cm in longitudinal direction one after the other to the desired substrate. A tab is applied as a grip aid to the initial portion of the first liner. In addition, both liners are connected to a bridge composed of a tab, by welding one end of the tab to the end region of the first liner and the other end of the tab to the initial region of the second liner of the other strip. The welding is carried out at 190° C. with a pressure of 3 bar and during a welding time of 3 seconds, using a metal stamp. A PET/PE laminate is used as tab and bridge. The purpose of the grip tab is to remove the liner from the test tape in one step.

In the Tabbing Test of this Example, the following evaluation scheme was employed:
“+” means that the liner can be removed by tab and bridge 100% in one step from the test tape, independently of the position of tab and bridge on the test tape,
“o” means that the liner can be removed by tab and bridge 100% in one step from the test tape if tab and bridge are positioned directly at the border of the test tape, and
“−” means that the liner cannot be removed from the test tape. The tab tears from the liner or the individual layers of the liner split.

The Tabbing performance test and Delamination test results of this example are reported below in Table 1.

TABLE 1

| Liner No. | Delamination Test (N/cm) | Tabbing Test |
|---|---|---|
| 1 | 18.68 | + |
| 2 (comparative) | 11.03 | + |

Embodiment 1. A release liner is provided that includes: a POL layer system comprising one or more layers; at least one PEL layer; and an anchoring layer, the anchoring layer connects each PEL layer to the POL layer system. Further, each layer of the POL system has at least 80% by weight of one or more polyolefins, based on a total weight of the layer of the POL layer system. Each layer of the POL layer system comprises polypropylene. Each PEL layer comprises at least 80% by weight of polyethylene, based on a total weight of the PEL layer. In addition, the anchoring layer comprises at least one polyolefin copolymer.

Embodiment 2. The release liner of Embodiment 1 is provided, wherein the polyethylene of each PEL layer is a low-density polyethylene (LDPE).

Embodiment 3. The release liner of Embodiment 2 is provided, wherein the LDPE of each PEL layer has a density of ≤0.925 g/m³.

Embodiment 4. The release liner of Embodiment 1 is provided, wherein each PEL layer has a layer thickness of from 10 μm to 45 μm.

Embodiment 5. The release liner of Embodiment 1 is provided, wherein the POL layer system comprises a PPK layer comprising at least 80% by weight of polypropylene, based on a total weight of the PPK layer.

Embodiment 6. The release liner of Embodiment 1 is provided, wherein the POL layer system consists of a PPK layer comprising at least 60% by weight of polypropylene, based on a total weight of the PPK layer.

Embodiment 7. The release liner of Embodiment 1 is provided, wherein the POL layer system comprises a PPK layer and a POK layer, the POK layer directly following the PPK layer and comprising at least 25% by weight of polyethylene and at least 20% by weight of polypropylene, based on a total weight of the POK layer, and further wherein the PPK layer comprises at least 60% by weight of polypropylene, based on a total weight of the PPK layer.

Embodiment 8. The release liner of Embodiment 1 is provided, further including at least one silicone release layer, wherein the at least one silicone layer serves as the outermost layer of the release liner.

Embodiment 9. A method for producing a release liner is provided that includes: a step of coextruding a release liner. The release liner includes: a POL layer system comprising one or more layers; at least one PEL layer; and an anchoring layer, the anchoring layer connects each PEL layer to the POL layer system. Further, each layer of the POL system has at least 80% by weight of one or more polyolefins, based on a total weight of the layer of the POL layer system. Each layer of the POL layer system comprises polypropylene. Each PEL layer comprises at least 80% by weight of polyethylene, based on a total weight of the PEL layer. In addition, the anchoring layer comprises at least one polyolefin copolymer.

Embodiment 10. The method of Embodiment 9 is provided, wherein the coextruding step is conducted as a single step.

Embodiment 11. A release liner is provided that includes: a POL layer system comprising one or more layers; at least one PEL layer; and at least one anchoring layer, each anchoring layer connects each PEL layer to the POL layer system. Further, each layer of the POL system has at least 80% by weight of one or more polyolefins, based on a total weight of the layer of the POL layer system. Each layer of the POL layer system comprises polypropylene. Each PEL layer comprises at least 80% by weight of polyethylene, based on a total weight of the PEL layer. In addition, the at least one anchoring layer comprises at least one ethylene-propylene copolymer and a thickness of not more than 20 μm.

Embodiment 12. The release liner of Embodiment 11 is provided, wherein the anchoring layer comprises at least 80% by weight of at least one ethylene-propylene block copolymer, based on a total weight of the anchoring layer.

Embodiment 13. The release liner of Embodiment 11 is provided, wherein the polyethylene of each PEL layer is a low-density polyethylene (LDPE).

Embodiment 14. The release liner of Embodiment 13 is provided, wherein the LDPE of each PEL layer has a density of ≤0.925 g/m³.

Embodiment 15. The release liner of Embodiment 11 is provided, wherein each PEL layer has a layer thickness of from 10 μm to 45 μm.

Embodiment 16. The release liner of Embodiment 11 is provided, wherein the POL layer system consists of a PPK layer comprising at least 80% by weight of polypropylene, based on a total weight of the PPK layer, wherein the at least one PEL layer comprises a first and a second PEL layer disposed on a top and a bottom surface of the PPK layer, respectively, and further wherein the at least one anchoring layer comprises a first and a second anchoring layer that connects the first and second PEL layer to the PPK layer, respectively.

Embodiment 17. The release liner of Embodiment 16 is provided, wherein each of the first and second PEL layers, and the first and second anchoring layers, have substantially the same thickness.

Embodiment 18. The release liner of Embodiment 11 is provided, wherein the POL layer system consists of a first and a second POK layer disposed on a top and bottom surface of a PPK layer, respectively, wherein each POK layer comprises at least 25% by weight of polyethylene and at least 20% by weight of polypropylene, based on a total weight of each POK layer, and the PPK layer comprises at least 80% by weight of polypropylene, based on a total weight of the PPK layer, wherein the at least one PEL layer is a PEL layer disposed on a surface of the second POK layer, and further wherein the at least one anchoring layer is an anchoring layer that connects the PEL layer to the second POK layer.

Embodiment 19. The release liner of Embodiment 18 is provided, wherein the second POK layer has a thickness that is less than a thickness of the first POK layer.

Embodiment 20. The release liner of Embodiment 11 is provided, further including at least one silicone release layer, wherein the at least one silicone layer serves as the outermost layer of the release liner.

We claim:

1. A release liner for use on pressure-sensitive adhesives, comprising:
a POL layer system comprising one or more layers;
at least one PEL layer; and
an anchoring layer, the anchoring layer connects each PEL layer to the POL layer system,
wherein each layer of the POL layer system has at least 80% by weight of one or more polyolefins, based on a total weight of the layer of the POL layer system,
wherein each layer of the POL layer system comprises polypropylene,
wherein each PEL layer comprises at least 80% by weight of polyethylene, based on a total weight of the PEL layer, and
further wherein the anchoring layer comprises at least one polyolefin copolymer.

2. The release liner of claim 1, wherein the polyethylene of each PEL layer is a low-density polyethylene (LDPE).

3. The release liner of claim 2, wherein the LDPE of each PEL layer has a density of ≤0.925 g/m³.

4. The release liner of claim 1, wherein each PEL layer has a layer thickness of from 10 μm to 45 μm.

5. The release liner of claim 1, wherein the POL layer system comprises a PPK layer comprising at least 80% by weight of polypropylene, based on a total weight of the PPK layer.

6. The release liner of claim 1, wherein the POL layer system consists of a PPK layer comprising at least 60% by weight of polypropylene, based on a total weight of the PPK layer.

7. The release liner of claim 1, wherein the POL layer system comprises a PPK layer and a POK layer, the POK layer directly following the PPK layer and comprising at least 25% by weight of polyethylene and at least 20% by weight of polypropylene, based on a total weight of the POK layer, and further wherein the PPK layer comprises at least 60% by weight of polypropylene, based on a total weight of the PPK layer.

8. The release liner of claim 1, further comprising:
at least one silicone release layer, wherein the at least one silicone layer serves as the outermost layer of the release liner.

9. A method for producing a release liner for use on pressure-sensitive adhesives, comprising:
coextruding a release liner, wherein the release liner comprises:
a POL layer system comprising one or more layers;
at least one PEL layer; and
an anchoring layer, the anchoring layer connects each PEL layer to the POL layer system,
wherein each layer of the POL layer system has at least 80% by weight of one or more polyolefins, based on a total weight of the layer of the POL layer system,
wherein each layer of the POL layer system comprises polypropylene,
wherein each PEL layer comprises at least 80% by weight of polyethylene, based on a total weight of the PEL layer, and
further wherein the anchoring layer comprises at least one polyolefin copolymer.

10. The method of claim 9, wherein the coextruding step is conducted as a single step.

11. A release liner for use on pressure-sensitive adhesives, comprising:
a POL layer system comprising one or more layers;
at least one PEL layer; and
at least one anchoring layer, each anchoring layer connects each PEL layer to the POL layer system,
wherein each layer of the POL layer system has at least 80% by weight of one or more polyolefins, based on a total weight of the layer of the POL layer system,
wherein each layer of the POL layer system comprises polypropylene,
wherein each PEL layer comprises at least 80% by weight of polyethylene, based on a total weight of the PEL layer, and
further wherein the at least one anchoring layer comprises at least one ethylene-propylene block copolymer and a thickness of not more than 20 μm.

12. The release liner of claim 11, wherein the anchoring layer comprises at least 80% by weight of at least one ethylene-propylene block copolymer, based on a total weight of the anchoring layer.

13. The release liner of claim 11, wherein the polyethylene of each PEL layer is a low-density polyethylene (LDPE).

14. The release liner of claim 13, wherein the LDPE of each PEL layer has a density of ≤0.925 g/m³.

15. The release liner of claim 11, wherein each PEL layer has a layer thickness of from 10 μm to 45 μm.

16. The release liner of claim 11, wherein the POL layer system consists of a PPK layer comprising at least 80% by weight of polypropylene, based on a total weight of the PPK layer, wherein the at least one PEL layer comprises a first and a second PEL layer disposed on a top and a bottom surface of the PPK layer, respectively, and further wherein the at least one anchoring layer comprises a first and a second anchoring layer that connects the first and second PEL layer to the PPK layer, respectively.

17. The release liner of claim 16, wherein each of the first and second PEL layers, and the first and second anchoring layers, has substantially the same thickness.

18. The release liner of claim 11, wherein the POL layer system consists of a first and a second POK layer disposed on a top and bottom surface of a PPK layer, respectively, wherein each POK layer comprises at least 25% by weight of polyethylene and at least 20% by weight of polypropylene, based on a total weight of each POK layer, and the PPK layer comprises at least 80% by weight of polypropylene, based on a total weight of the PPK layer, wherein the at least one PEL layer is a PEL layer disposed on a surface of the second POK layer, and further wherein the at least one anchoring layer is an anchoring layer that connects the PEL layer to the second POK layer.

19. The release liner of claim 18, wherein the second POK layer has a thickness that is less than a thickness of the first POK layer.

20. The release liner of claim 11, further comprising:
at least one silicone release layer, wherein the at least one silicone layer serves as the outermost layer of the release liner.
